(19) United States
(12) Patent Application Publication
(10) Pub. No.: US 2017/0347335 A1
(43) Pub. Date: Nov. 30, 2017

(54) METHOD AND APPARATUS FOR TRANSMITTING PAGING FOR MACHINE TYPE COMMUNICATION USER EQUIPMENT IN WIRELESS COMMUNICATION SYSTEM

(71) Applicant: LG ELECTRONICS INC., Seoul (KR)

(72) Inventors: Yunjung YI, Seoul (KR); Joonkui AHN, Seoul (KR); Hyangsun YOU, Seoul (KR)

(73) Assignee: LG ELECTRONICS INC., Seoul (KR)

(21) Appl. No.: 15/524,599

(22) PCT Filed: Nov. 5, 2015
(86) PCT No.: PCT/KR2015/011863

§ 371 Date: May 4, 2017

Related U.S. Application Data
(60) Provisional application No. 62/075,877, filed on Nov. 5, 2014.
(60) Provisional application No. 62/107,504, filed on Jan. 26, 2015.
(60) Provisional application No. 62/235,585, filed on Oct. 1, 2015.

(51) Int. Cl. H04W 68/02; H04W 76/02; H04W 4/00

(52) U.S. Cl. CPC H04W 68/02; H04W 4/006; H04W 76/02

(57) ABSTRACT

A method and apparatus for monitoring a paging in a wireless communication system is provided. A user equipment (UE) monitors multiple paging instances at one paging occasion. Specifically, the UE monitors a first paging instance with a first repetition level in a paging occasion, and monitors a second paging instance with a second repetition level, which is higher than the first repetition level, in the paging occasion.

### BACKGROUND OF THE INVENTION

### Field of the Invention

The present invention relates to wireless communications, and more particularly, to a method and apparatus for transmitting a paging for a machine type communication user equipment (MTC UE) in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

In the future versions of the LTE-A, it has been considered to configure low-cost/low-end (or, low-complexity) user equipments (UEs) focusing on the data communication, such as meter reading, water level measurement, use of security camera, vending machine inventory report, etc. For convenience, these UEs may be called machine type communication (MTC) UEs. Since MTC UEs have small amount of transmission data and have occasional uplink data transmission/downlink data reception, it is efficient to reduce the cost and battery consumption of the UE according to a low data rate. Specifically, the cost and battery consumption of the UE may be reduced by decreasing radio frequency (RF)/baseband complexity of the MTC UE significantly by making the operating frequency bandwidth of the MTC UE smaller.

Paging is the mechanism in which the network tells UE saying “I have something for you”. Then the UE decode the content (paging cause) of the paging message and the UE has to initiate the appropriate procedure. In most cases, this paging process happens while the UE is in idle mode. This means that the UE has to monitor whether the network transmits any paging message to the UE and the UE has to spend some energy (battery) to run this monitoring process. Accordingly, a method for transmitting a paging for MTC UEs efficiently may be required.

### SUMMARY OF THE INVENTION

The present invention provides a method and apparatus for transmitting a paging for a machine type communication user equipment (MTC UE) in a wireless communication system. The present invention provides a method and apparatus for performing periodic reporting triggered by paging for low complexity MTC UEs. The present invention provides a method and apparatus for addressing a paging mechanism for low complexity MTC UEs requiring coverage enhancement via such as repetition.

In an aspect, a method for monitoring, by a user equipment (UE), a paging in a wireless communication system is provided. The method includes monitoring a first paging instance with a first repetition level in a paging occasion, and monitoring a second paging instance with a second repetition level, which is higher than the first repetition level, in the paging occasion.

In another aspect, a user equipment (UE) is provided. The UE includes a memory, a transceiver, and a processor coupled to the memory and the transceiver, and configured to monitor a first paging instance with a first repetition level, and monitor a second paging instance with a second repetition level which is higher than the first repetition level.

MTC UEs can be paged efficiently.

### BRIEF DESCRIPTION OF THE DRAWINGS

FIG. 1 shows a wireless communication system.

FIG. 2 shows structure of a radio frame of 3GPP LTE.

FIG. 3 shows a resource grid for one downlink slot.

FIG. 4 shows structure of a downlink subframe.

FIG. 5 shows structure of an uplink subframe.

FIG. 6 shows an overall paging timing to support coverage enhancement for MTC UEs according to an embodiment of the present invention.

FIG. 7 shows increase of coverage enhancement levels or repetition levels according to an embodiment of the present invention.

FIG. 8 shows a method for monitoring a paging according to an embodiment of the present invention.

FIG. 9 shows a wireless communication system to implement an embodiment of the present invention.

### DESCRIPTION OF EXEMPLARY EMBODIMENTS

Techniques, apparatus and systems described herein may be used in various wireless access technologies such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented with a radio technology such as universal terrestrial radio access (UTRA) or CDMA2000. The TDMA may be implemented with a radio technology such as global system for mobile communications (GSM)/general packet radio service (GPRS)/enhanced data rates for GSM evolution (EDGE). The OFDMA may be implemented with a radio technology such as institute of electrical and electronics engineers (IEEE) 802.11 (Wi-Fi), IEEE 802.16 (WiMAX), IEEE 802-20, evolved-UTRA (E-UTRA) etc. The UTRA is a part of a universal mobile telecommunication system (UMTS). 3rd generation partnership project (3GPP) long term evolution (LTE) is a part of an evolved-UMTS (E-UMTS) using the E-UTRA. The 3GPP LTE employs the OFDMA in downlink (DL) and employs the SC-FDMA in uplink (UL). LTE-advance (LTE-A) is an evolution of the 3GPP LTE. For clarity, this application focuses on the 3GPP LTE/LTE-A. However, technical features of the present invention are not limited thereto.

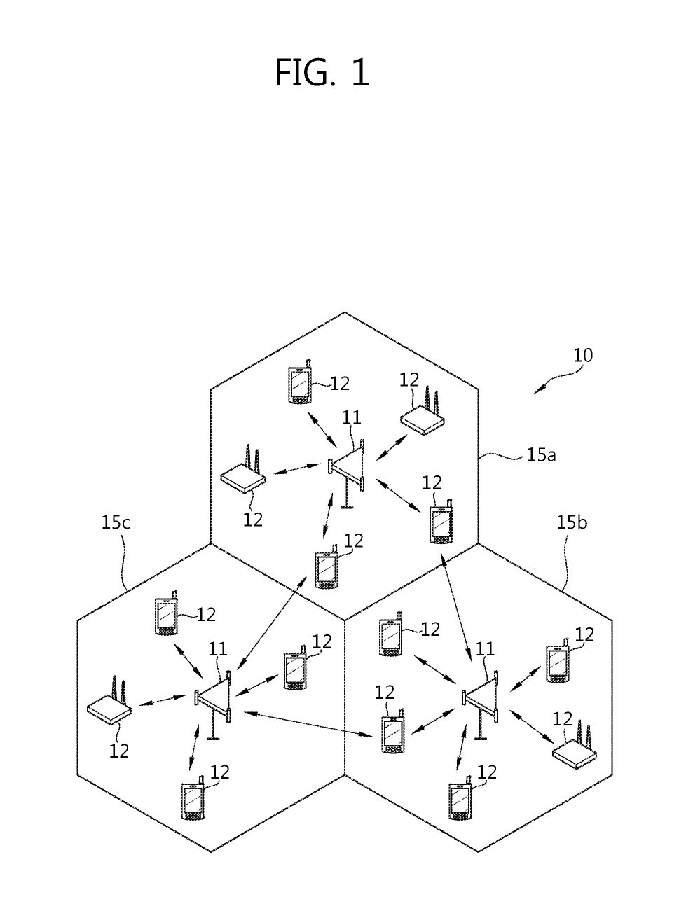

FIG. 1 shows a wireless communication system. The wireless communication system 10 includes at least one evolved NodeB (eNB) 11. Respective eNBs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile terminal (MT), user terminal (UT), subscriber station (SS), wireless device, personal digital assistant (PDA), wireless modem, handheld device. The eNB 11 generally refers to a fixed station that communicates with the UE 12 and may be called by other names such as base station (BS), base transceiver system (BTS), access point (AP), etc.

In general, a UE belongs to one cell, and the cell to which a UE belongs is called a serving cell. An eNB providing a communication service to the serving cell is called a serving eNB. The wireless communication system is a cellular system, so a different cell adjacent to the serving cell exists. The different cell adjacent to the serving cell is called a neighbor cell. An eNB providing a communication service to the neighbor cell is called a neighbor eNB. The serving cell and the neighbor cell are relatively determined based on a UE.

This technique can be used for DL or UL. In general, DL refers to communication from the eNB 11 to the UE 12, and UL refers to communication from the UE 12 to the eNB 11. In DL, a transmitter may be part of the eNB 11 and a receiver may be part of the UE 12. In UL, a transmitter may be part of the UE 12 and a receiver may be part of the eNB 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

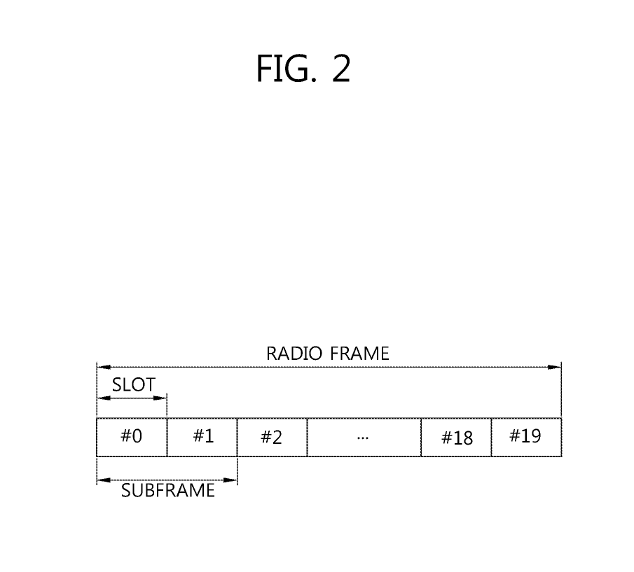

FIG. 2 shows structure of a radio frame of 3GPP LTE. Referring to FIG. 2, a radio frame includes 10 subframes. A subframe includes two slots in time domain. A time for transmitting one subframe is defined as a transmission time interval (TTI). For example, one subframe may have a length of 1 ms, and one slot may have a length of 0.5 ms. One slot includes a plurality of orthogonal frequency division multiplexing (OFDM) symbols in time domain. Since the 3GPP LTE uses the OFDMA in the DL, the OFDM symbol is for representing one symbol period. The OFDM symbols may be called by other names depending on a multiple-access scheme. For example, when SC-FDMA is in use as a UL multi-access scheme, the OFDM symbols may be called SC-FDMA symbols. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

The wireless communication system may be divided into a frequency division duplex (FDD) scheme and a time division duplex (TDD) scheme. According to the FDD scheme, UL transmission and DL transmission are made at different frequency bands. According to the TDD scheme, UL transmission and DL transmission are made during different periods of time at the same frequency band. A channel response of the TDD scheme is substantially reciprocal. This means that a DL channel response and a UL channel response are almost the same in a given frequency band. Thus, the TDD-based wireless communication system is advantageous in that the DL channel response can be obtained from the UL channel response. In the TDD scheme, the entire frequency band is time-divided for UL and DL transmissions, so a DL transmission by the eNB and a UL transmission by the UE cannot be simultaneously performed. In a TDD system in which a UL transmission and a DL transmission are discriminated in units of subframes, the UL transmission and the DL transmission are performed in different subframes.

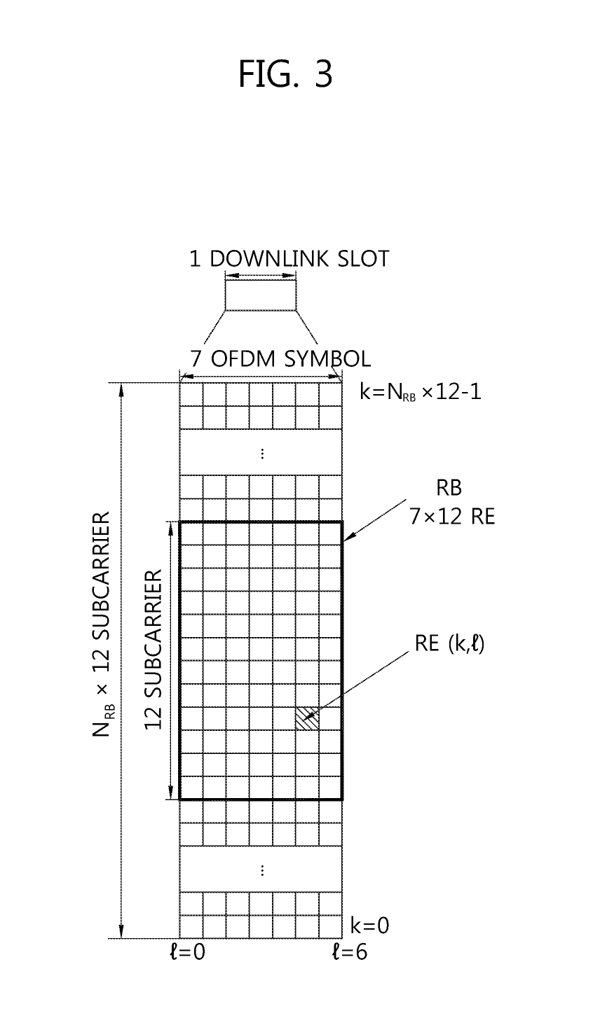

FIG. 3 shows a resource grid for one downlink slot. Referring to FIG. 3, a DL slot includes a plurality of OFDM symbols in time domain. It is described herein that one DL slot includes 7 OFDM symbols, and one RB includes 12 subcarriers in frequency domain as an example. However, the present invention is not limited thereto. Each element on the resource grid is referred to as a resource element (RE). One RB includes 12×7 resource elements. The number N^{DL} of RBs included in the DL slot depends on a DL transmit bandwidth. The structure of a UL slot may be same as that of the DL slot. The number of OFDM symbols and the number of subcarriers may vary depending on the length of a CP, frequency spacing, etc. For example, in case of a normal cyclic prefix (CP), the number of OFDM symbols is 7, and in case of an extended CP, the number of OFDM symbols is 6. One of 128, 256, 512, 1024, 1536, and 2048 may be selectively used as the number of subcarriers in one OFDM symbol.

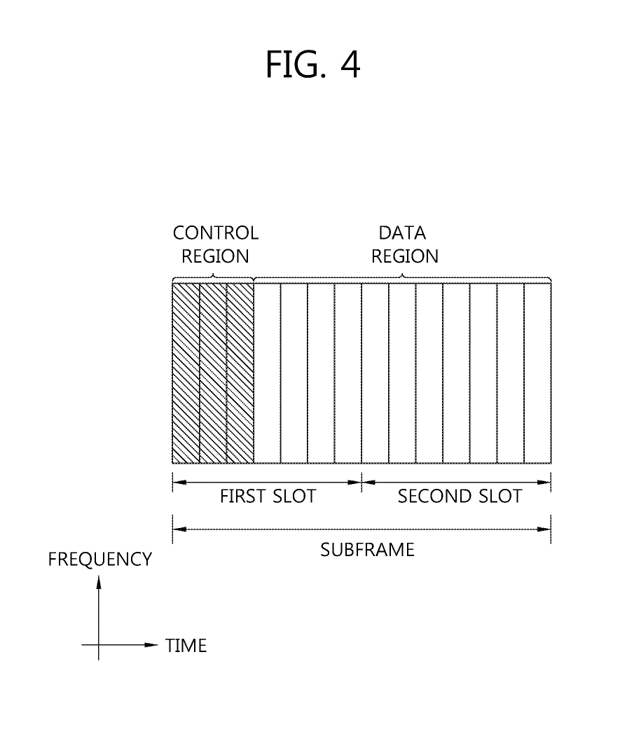

FIG. 4 shows structure of a downlink subframe. Referring to FIG. 4, a maximum of three OFDM symbols located in a front portion of a first slot within a subframe correspond to a control region to be assigned with a control channel. The remaining OFDM symbols correspond to a data region to be assigned with a physical downlink shared chancel (PDSCH). Examples of DL control channels used in the 3GPP LTE includes a physical control format indicator channel (PCFICH), a physical downlink control channel (PDCCH), a physical hybrid automatic repeat request (HARQ) indicator channel (PHICH), etc. The PCFICH is transmitted at a first OFDM symbol of a subframe and carries information regarding the number of OFDM symbols used for transmission of control channels within the subframe. The PHICH is a response of UL transmission and carries a HARQ acknowledgment (ACK)/non-acknowledgment (NACK) signal. Control information transmitted through the PDCCH is referred to as downlink control information (DCI). The DCI includes UL or DL scheduling information or includes a UL transmit (TX) power control command for arbitrary UE groups.

The PDCCH may carry a transport format and a resource allocation of a downlink shared channel (DL-SCH), resource allocation information of an uplink shared channel (UL-SCH), paging information on a paging channel (PCH), system information on the DL-SCH, a resource allocation of an upper-layer control message such as a random access response transmitted on the PDSCH, a set of TX power control commands on individual UEs within an arbitrary UE group, a TX power control command, activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups.

A format of the PDCCH and the number of bits of the available PDCCH are determined according to a correlation between the number of CCEs and the coding rate provided by the CCEs. The eNB determines a PDCCH format according to a DCI to be transmitted to the UE, and attaches a cyclic redundancy check (CRC) to control information. The CRC is scrambled with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be scrambled to the CRC. Alternatively, if the PDCCH is for a paging message, a paging indicator identifier (e.g., paging-RNTI (P-RNTI)) may be scrambled to the CRC. If the PDCCH is for system information (more specifically, a system information block (SIB) to be described below), a system information identifier and a system information RNTI (SI-RNTI) may be scrambled to the CRC. To indicate a random access response that is a response for transmission of a random access preamble of the UE, a random access-RNTI (RA-RNTI) may be scrambled to the CRC.

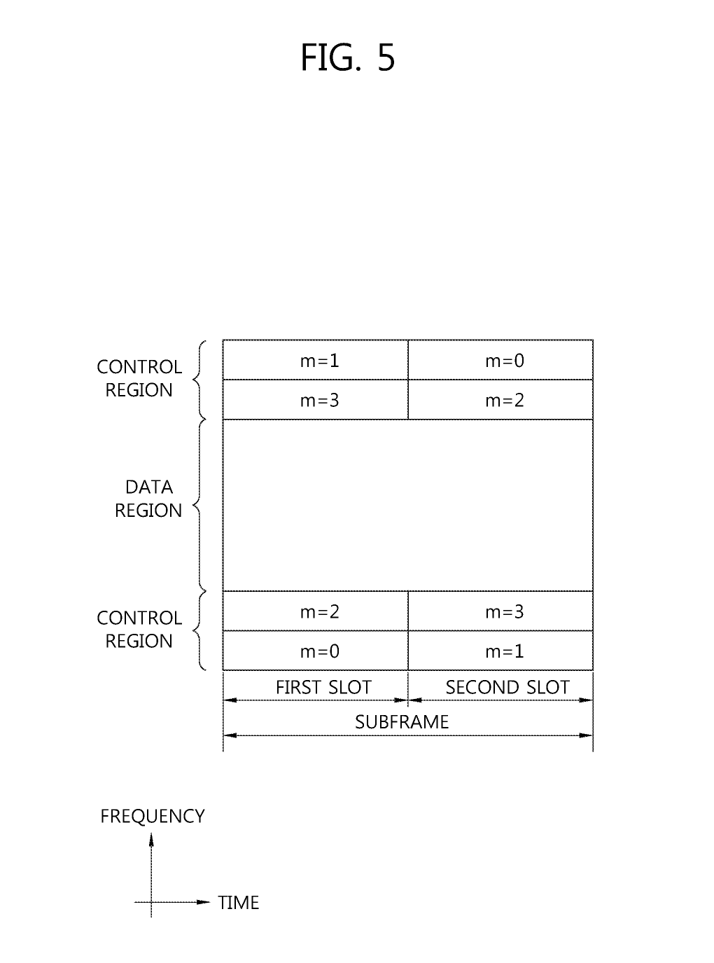

FIG. 5 shows structure of an uplink subframe. Referring to FIG. 5, a UL subframe can be divided in a frequency domain into a control region and a data region. The control region is allocated with a physical uplink control channel (PUCCH) for carrying UL control information. The data region is allocated with a physical uplink shared channel (PUSCH) for carrying user data. When indicated by a higher layer, the UE may support a simultaneous transmission of the PUSCH and the PUCCH. The PUCCH for one UE is allocated to an RB pair in a subframe. RBs belonging to the RB pair occupy different subcarriers in respective two slots. This is called that the RB pair allocated to the PUCCH is frequency-hopped in a slot boundary. This is said that the pair of RBs allocated to the PUCCH is frequency-hopped at the slot boundary. The UE can obtain a frequency diversity gain by transmitting UL control information through different subcarriers according to time.

UL control information transmitted on the PUCCH may include a HARQ ACK/NACK, a channel quality indicator (CQI) indicating the state of a DL channel, a scheduling request (SR), and the like. The PUSCH is mapped to a UL-SCH, a transport channel. UL data transmitted on the PUSCH may be a transport block, a data block for the UL-SCH transmitted during the TTI. The transport block may be user information. Or, the UL data may be multiplexed data. The multiplexed data may be data obtained by multiplexing the transport block for the UL-SCH and control information. For example, control information multiplexed to data may include a CQI, a precoding matrix indicator (PMI), an HARQ, a rank indicator (RI), or the like. Or the UL data may include only control information.

A radio resource control (RRC) state indicates whether an RRC layer of the UE is logically connected to an RRC layer of the evolved universal terrestrial radio access network (E-UTRAN). The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by non-access stratum (NAS), and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

Discontinuous reception for paging is further described. The UE may use DRX in idle mode in order to reduce power consumption. One paging occasion (PO) is a subframe in which there may be P-RNTI transmitted on PDCCH addressing the paging message. One paging frame (PF) is one radio Frame, which may contain one or multiple PO(s). When DRX is used, the UE needs only to monitor one PO per DRX cycle.

The PF and PO is determined by following equations using the DRX parameters provided in system Information. PF is given by Equation 1 below.

SFN mod T=(T div N)*(UE_ID mod N) <Equation 1>

Index i_s pointing to PO from subframe pattern is derived from Equation 2 below.

i_s=floor(UE_ID/N)mod Ns <Equation 2>

System information DRX parameters stored in the UE shall be updated locally in the UE whenever the DRX parameter values are changed in system information. If the UE has no international mobile subscriber identity (IMSI), for instance when making an emergency call without universal subscriber identity module (USIM), the UE shall use as default identity UE_ID=0 in the PF and i_s equations above.

The following parameters are used for the calculation of the PF and i_s, shown in Equation 1 and Equation 2.
T: DRX cycle of the UE. T is determined by the shortest of the UE specific DRX value, if allocated by upper layers, and a default DRX value broadcast in system information. If UE specific DRX is not configured by upper layers, the default value is applied.
nB: 4T, 2T, T, T/2, T/4, T/8, T/16, T/32
N: min(T, nB)
Ns: max(1, nB/T)
UE_ID: IMSI mod 1024.

IMSI is given as sequence of digits of type Integer (0 . . . 9), and IMSI in the equations above shall be interpreted as a decimal integer number, where the first digit given in the sequence represents the highest order digit. For example, when IMSI=12 (digit1=1, digit2=2), in the calculations, this shall be interpreted as the decimal integer “12”, not “1×16+2=18”.

Table 1 shows paging subframe patterns for FDD.

TABLE 1

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

Table 2 shows paging subframe patterns for TDD (all UL/DL configurations).

TABLE 2

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

In the current LTE specification, all UEs shall support maximum 20 MHz system bandwidth, which requires baseband processing capability to support 20 MHz bandwidth. To reduce hardware cost and battery power of the UE used for machine type communication (MTC), reducing bandwidth is a very attractive option. To enable narrow-band MTC UEs, the current LTE specification shall be changed to allow narrow-band UE category. If the serving cell has small system bandwidth (smaller than or equal to bandwidth that narrow-band UE can support), the UE can attach based on the current LTE specification.

In normal MTC, it is expected that UL heavy traffic such as periodic reporting of sensor data is typical. To support a long-battery-life, it is also expected that a UE sleeps a long time and wakes up only for either event-triggered reporting or periodic reporting or sending keep-alive messages. When the UE wakes up, due to a rather long-time sleep, time/frequency tracking of the UE may be inaccurate. Thus, re-synchronization may be necessary. This is also true for UL transmission as well. Thus, transmitting necessary tracking signals such as cell-specific reference signal (CRS) is essential along with any DL data such as paging or wake-up signals. When the UE wakes up from paging or based on event/timer, before it transmits UL data, the UE also needs to transmit physical random access channel (PRACH)-like signals to align UL timing/frequency. To allow multiplexing of UEs, a mechanism to trigger periodic report based on paging may be considered. For example, the eNB may transmit paging to a set of UEs periodically which will be used for UL grants. Further, when a UE experiences limited coverage, it is also necessary to transmit repeated paging (paging retransmission or repetition) for coverage enhancement (CE). In this case, paging occasion and paging frame definition for a MTC UE needs to be changed. Furthermore, how to repeat paging also need to be clarified.

In order to solve the problem described above, a method for transmitting a paging for MTC UEs according to an embodiment of the present invention may be proposed. Hereinafter, all of a MTC UE, a low cost UE, a low end UE, a low complexity UE, a narrow(er) band UE, a small(er) band UE, or a new category UE may be used mixed with each other. Or, just UE may refer one of UEs described above. In the description below, a case where system bandwidth of available cells is larger than bandwidth that new category narrow-band UEs can support may be assumed. For the new category UE, it may be assumed that only one narrow-band is defined. In other words, all narrow-band UE shall support the same narrow bandwidth smaller than 20 MHz. It may be assumed that the narrow bandwidth is larger than 1.4 MHz (6 PRBs). However, the present invention may be applied to narrower bandwidth less than 1.4 MHz as well (e.g. 200 kHz), without loss of generality. More generally, the present invention may apply to a case where the system has large bandwidth such as 160 MHz, whereas the UE may support smaller bandwidth size such as 20 MHz as well.

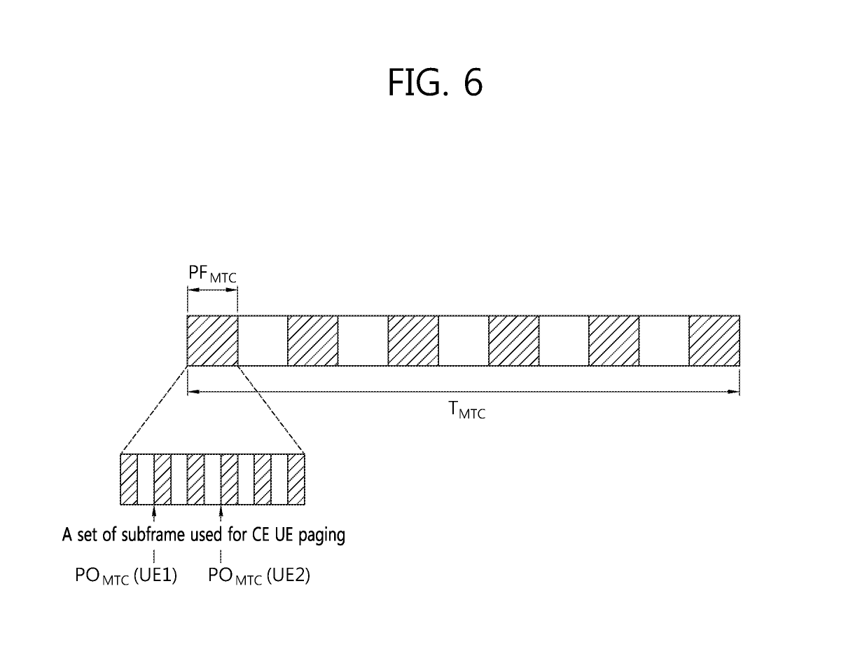

FIG. 6 shows an overall paging timing to support coverage enhancement for MTC UEs according to an embodiment of the present invention. Referring to FIG. 6, for MTC UEs in coverage enhancement mode, T_{MTC} may be defined in a predetermined value or signaled by SIB/master information block (MIB), which may contain the cycle duration of paging instance to MTC UEs in coverage enhancement mode. This is different from no coverage enhancement where paging frame can occur in every T where T is the default DRX cycle in RRC_IDLE broadcasted by SIB or minimum DRX cycle in RRC_CONNECTED. The cycle duration of paging instance may be defined as overall periodicity of MTC UE reporting such as for smart meter applications. T_{MTC} may be defined in consideration of both periodicity of wake-up or paging and the maximum coverage enhancement level that the network supports. If the network supports e.g. 15 dB enhancement and thus may support up to 100 times of repetition of paging, one paging frame occasion for a MTC UE may be larger than 100 subframes. PF_{MTC} may define the number of subframes or the number of radio frames where one paging instance may require. PF_{MTC} may be defined based on the maximum coverage level that the network supports. Within a PF_{MTC}, a set of subframe/radio frames may be allocated for paging purpose in a predetermined or via higher layer signaling such as SIB.

In terms of determining the location of paging/paging frame, the current function may be reused. Since the network may not know the coverage enhancement level that a UE may require, the network may transmit the maximum repetition that the network supports for every UE. Alternatively, the network may use previous coverage enhancement level that the specific UE has been configured/used (which was successful), and if the transmission fails (i.e. no feedback has been received from the UE), the network may increase the coverage enhancement level. However, given that paging may not occur so often particularly for MTC UEs in coverage enhancement mode, it is desirable to always use maximum coverage enhancement mode to support successful transmission. However, a MTC UE may stop monitoring/receiving repletion of paging once it succeeds the reception.

Starting subframe of paging repetition according to an embodiment of the present invention is described. To determine the starting subframe of repeated paging, according to an embodiment of the present invention, paging may be transmitted without PDCCH with preconfigured modulation and coding scheme (MCS) and resource allocation. In this case, the starting position/subframe of the repeated paging may start at PF_{MTC} and the repetition may continue every PO_{MTC} opportunity (i.e. paging occasion configured not only for the given UE as well for other UEs) in each PF_{MTC}. Further, in order to indicate starting set of PF_{MTC} or set of PO_{MTC} where a UE may expect the repeated paging may start. In terms of determining PF_{MTC}, UE-specific or P-RNTI-based function, which is similar to the current function, may be used. In this case, the first PO within a PF may be used as a starting subframe for the repeated paging transmission. In this case, to determine the paging location for a UE, the following function may be used. PF may be given by Equation 3. Further, PO_{MTC}=0.

SFN*M mod T*M=(T*M div N*M)*(UE_ID mod N) <Equation 3>

In Equation 3, the following parameters may be used.
T: Size of one paging cycle (e.g. the number of UEs or the number of P-RNTIs supported in one paging cycle), which is predetermined or higher layer signaled
M: The number of radio frames within one PF_{MTC}. For example, M=4 may mean that 40 subframes consist one PF_{MTC}.
nB: 4T, 2T, T, T/2, T/4, T/8, T/16, T/32
N: min(T, nB)
Ns: max(1, nB/T)
UE_ID: IMSI mod 1024.

Alternatively, the starting position/subframe of the repeated paging may start at PF_{MTC}/PO_{MTC} and the repetition may continue in successive DL subframes. In this case, it is desirable that the size of PF_{MTC} is larger than the required number of subframes to transmit repeated/retransmitted paging. One example may be to set the size of PF_{MTC}=2*maximum number of repetition (e.g. 100) and PO_{MTC} may be placed only in first half of PF_{MTC} duration such that all UEs can be scheduled with the maximum repetition number within one PF_{MTC}. For this, PF_{MTC} may be determined as the same as the first approach, i.e. by Equation 3 described above. Paging occasion may be determined by Equation 4, which distributes UEs uniformly within one half of PF_{MTC}.

i_s=UE_ID mod M*10/2 <Equation 4>

The set of subframes/radio frames used for paging repetition may be determined based on UE ID or P-RNTI. For example, one PF_{MTC}=PO_{MTC} size*number of UE IDs (or number of P-RNTIs), where the size of PO_{MTC} may be larger than the maximum repetition number for paging. In that case, the starting subframe of repetition may be the first subframe within a PO_{MTC}. This approach is similar to the first approach. The difference is that the paging occasion frame may be determined solely by UE ID or P-RNTI such as K=(UE_ID mod N), where K is the index of PF_{MTC} and N is the maximum number of UE IDs (or number of P-RNTIs) that the system supports.

According to another embodiment of the present invention, paging may be transmitted with PDCCH. In this case, approaches described above for paging without PDCCH may be applied similarly. Once PDCCH is transmitted, in terms of PDSCH, the following options may be considered.
PDSCH repetition may start at K subframe (e.g. K=1 or 2) after end of the PDCCH repetition
Two separate PF_{MTC}/PO_{MTC} for PDCCH/PDSCH may be defined where the repetition of PDCCH/PDSCH occurs in each set respectively.
PDCCH may indicate a set of subframes where PDSCH are transmitted.
Other options used for repeating PDCCH and PDSCH may be also applicable to paging retransmission.

Meanwhile, PDCCH for MTC UEs (hereinafter, M-PDCCH) is used to schedule paging transmission, paging occasion may be configured in consideration of repetition number or aligned with repetition number. The network may configure at least one of the followings via SIB.
Periodicity of M-PDCCH (the largest repetition number of M-PDCCH): It is generally desirable to have multiple of radio frame for this periodicity, and also, it is desirable that the maximum number of system frame number (SFN) can divide this repetition number.
(optionally) offset indicating when the period starts
Repetition number of M-PDCCH

For M-PDCCH used for paging, the repetition may occur only valid subframe configured by SIB1. Further, a set of paging subframe where M-PDCCH and/or paging PDSCH may be transmitted. In terms of paging occasion configuration, the following may be considered. PF may be given by Equation 5.

SFN*M mod T*M=(T*M div N*M)*(UE_ID mod floor(N/P)*P) <Equation 5>

In Equation 5, the following parameters may be used.
T: Size of one paging cycle (e.g. the number of UEs or the number of P-RNTIs supported in one paging cycle), which is predetermined or higher layer signaled
M: The number of radio frames within one PF_{MTC}. For example, M=4 may mean that 40 subframes consist one PF_{MTC}.
nB: 4T, 2T, T, T/2, T/4, T/8, T/16, T/32
N: min(T, nB)
Ns: max(1, nB/T)
IMSI mod 1024.
P: the periodicity in radio frame unit.

By this way, paging occasion may be aligned with the starting subframes of M-PDCCH monitoring for paging transmission. Other configuration may be also considered which aligns the starting subframe of M-PDCCH with paging occasion. If paging occasion and starting subframe of M-PDCCH is not aligned, a UE may start monitoring of M-PDCCH monitoring occasions within paging occasion.

In addition to the above configuration, paging duration may be configured in SIB via some signaling. For example, the paging duration may be multiple of M-PDCCH monitoring window. If a UE is monitoring multiple repetition levels, it will be based on the largest repetition number. Or, separate configuration per each repetition level may be also considered. Further, for PDSCH where paging is transmitted, the PDSH may be scheduled outside of paging occasion. The starting offset of PDSCH may be signaled from M-PDCCH or via SIB.

Handling of dynamic/variable CE/repetition level according to an embodiment of the present invention is described. For a MTC UE in coverage enhancement mode, it is likely that CE/repetition level for paging message may change even though the UE may be static due to channel/environments change. Since paging generally occurs for a UE in RRC_IDLE, tight management of CE/repetition level does not seem to be feasible or feedback from UE regarding CE/repetition level may not be easily assumed. In this case, overall change of CE/repetition level may be performed as described below.

If it is assumed that a mobility management entity (MME) may increase CE/repetition level in case of retransmission, since the UE may not know whether there is a retransmission or not, the UE may have to monitor multiple resource candidates where paging can be transmitted at one time. Or, multiple resource candidates may be configured such that a UE may monitor different resources with different repetition level at each time. For example, at each paging occasion, instead of a UE monitoring one instance of paging, the UE may monitor multiple paging instances with potentially different repetition level. Specifically, since the UE does not know the CE/repetition level, the UE may monitor paging instances, from the minimum CE/repetition level to the maximum CE/repetition level.

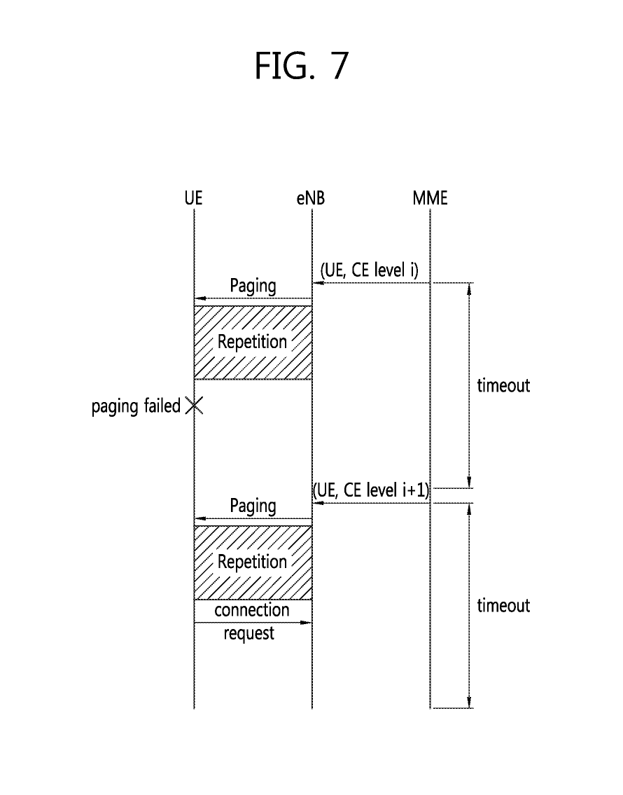

FIG. 7 shows increase of coverage enhancement levels or repetition levels according to an embodiment of the present invention. Referring to FIG. 7, at first, the MME initiates paging with CE level i. The eNB transmits the paging message to the UE with CE level i. However, in spite of repetition, the UE cannot receive the paging message. Accordingly, the MME increases CE level. The eNB transmits the paging message to the UE with CE level i+1. In this case, the UE can receive the paging message via repetition, and can transmit a connection request to the eNB.

As one approach, in order to transmit the paging message with different repetition levels, the paging message may be transmitted by utilizing a control channel format, such as PDCCH or enhanced PDCCH (EPDCCH) or a new control channel format, which allows multiplexing of different aggregation levels where different aggregation levels may be mapped to different CE/repetition levels. In this example, the number of repeated subframes may be fixed where different aggregation levels are used for different CE/repetition levels. In this case, to cover multiple CE/repetition levels, more aggregation levels may be used, or different aggregation levels may be used. For example, instead that aggregation levels of 1, 2, 4 and 8 is used, aggregation levels of 1, 4, 16, 256, and so on, may be used. The number of repeated PDSCH may be indicated by PDCCH or implicitly mapped to the aggregation level used for control channel or CE/repetition level used for control channel.

As another approach, repetition/CE level may be mapped to a subband or frequency location such that control channel may indirectly indicate CE/repetition level of PDSCH depending on resource allocation or subband allocation. Another approach is to configure the maximum number of repetitions based on the maximum CE/repetition level that the system supports or system supports for the paging, and the network may transmit the paging message with smaller number of repetition if the CE/repetition level used for paging is smaller than the maximum CE/repetition level. In this case, a UE needs to blindly search the end of repetition (e.g. by detecting discontinuous transmission (DTX), etc.). CE/repetition level change/determination mechanisms described here may be applied to other channels such unicast PDSCH or random access response (RAR).

Alternatively, multiple PO and/or PF may be configure for different CE/repetition levels. For example, m different number of PF_{MTC} and/or PO_{MTC} may be configured such that in one instance of paging, the UE may need to monitor multiple occasions with different CE/repetition levels. However, this approach leads higher latency to be able to receive paging with the appropriate CE/repetition level.

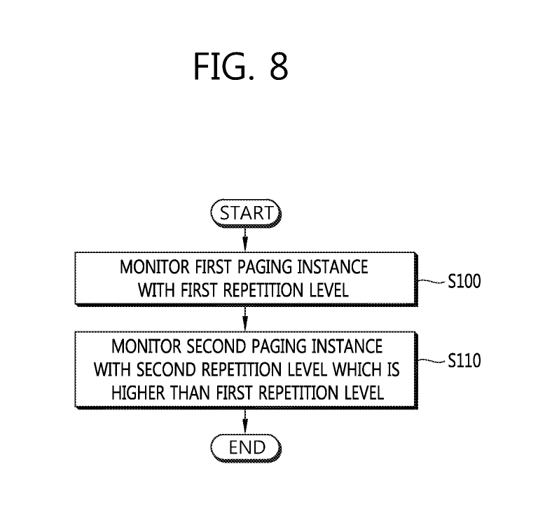

FIG. 8 shows a method for monitoring a paging according to an embodiment of the present invention. In step S100, the UE monitors a first paging instance with a first repetition level in a paging occasion. Paging in the first paging instance with the first paging repetition level may be failed. In step S110, the UE monitors a second paging instance with a second repetition level, which is higher than the first repetition level, in the paging occasion. Paging in the second paging instance with the second paging repetition level may be succeed. The first repetition level and the second repetition level may be provided by the MME to the eNB. In this case, the UE may transmit a connection request message to the eNB. The UE may be a low cost machine-type communication UE.

The first repetition level may correspond to a minimum repetition level. The second repetition level may correspond to a maximum repetition level. Monitoring the first paging instance or the second paging instance may comprise monitoring transmission of a paging message from an eNB in the first paging instance or the second paging instance. The paging message may be transmitted with a first aggregation level in the first paging instance, and the paging message may be transmitted with a second aggregation level in the second paging instance. The first repetition level may be mapped to the first aggregation level, and the second repetition level may be mapped to the second aggregation level.

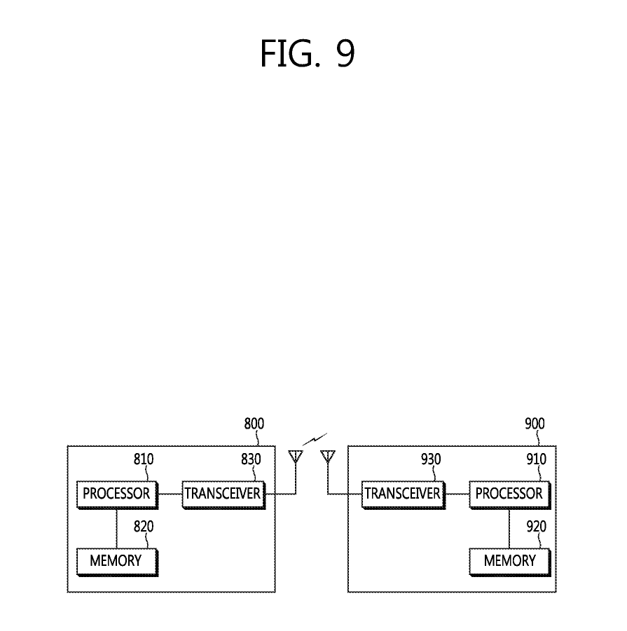

FIG. 9 shows a wireless communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A MTC UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for monitoring, by a user equipment (UE), a paging in a wireless communication system, the method comprising:
monitoring a first paging instance with a first repetition level in a paging occasion; and
monitoring a second paging instance with a second repetition level, which is higher than the first repetition level, in the paging occasion.

2. The method of claim 1, wherein paging in the first paging instance with the first paging repetition level is failed.

3. The method of claim 1, wherein paging in the second paging instance with the second paging repetition level is succeed.

4. The method of claim 3, further comprising transmitting a connection request message to an evolved NodeB (eNB).

5. The method of claim 1, wherein the first repetition level or the second repetition level is provided by a mobility management entity (MME) to an eNB.

6. The method of claim 1, wherein the first repetition level corresponds to a minimum repetition level.

7. The method of claim 1, wherein the second repetition level corresponds to a maximum repetition level.

8. The method of claim 1, wherein monitoring the first paging instance or the second paging instance comprises monitoring transmission of a paging message from an eNB in the first paging instance or the second paging instance.

9. The method of claim 8, wherein the paging message is transmitted with a first aggregation level in the first paging instance, and
wherein the paging message is transmitted with a second aggregation level in the second paging instance.

10. The method of claim 9, wherein the first repetition level is mapped to the first aggregation level, and
wherein the second repetition level is mapped to the second aggregation level.

11. The method of claim 1, wherein the UE is a low cost machine-type communication UE.

12. A user equipment (UE) comprising:
a memory;
a transceiver; and
a processor coupled to the memory and the transceiver, and configured to:
monitor a first paging instance with a first repetition level; and
monitor a second paging instance with a second repetition level which is higher than the first repetition level.

13-15. (canceled)

16. The method of claim 1, wherein the first paging instance and the second paging instance are monitored via a control channel for paging.

17. The method of claim 1, wherein the first repetition level and the second repetition level are determined based on a maximum coverage enhancement level.

18. The method of claim 17, wherein the maximum coverage enhancement level corresponds to a maximum number of repetitions for paging.
